(19) United States
(12) Patent Application Publication
(10) Pub. No.: US 2012/0130568 A1
(43) Pub. Date: May 24, 2012

(54) DATA COMMUNICATION SYSTEM FOR A RAIL VEHICLE CONSIST AND METHOD FOR COMMUNICATING DATA WITH A RAIL VEHICLE CONSIST

(75) Inventors: Samuel GOLDEN, Melbourne, FL (US); David Eldredge, Melbourne, FL (US); Robert Foy, Melbourne, FL (US); Stephen Smith, Melbourne, FL (US); John William Brand, Melbourne, FL (US); Kevin Kapp, Melbourne, FL (US)

(73) Assignee: General Electric Company, Schenectady, NY (US)

(21) Appl. No.: 13/046,808

(22) Filed: Mar. 14, 2011

Related U.S. Application Data
(60) Provisional application No. 61/415,385, filed on Nov. 19, 2010.

(51) Int. Cl. G05D 1/00; H04Q 5/22

(52) U.S. Cl. 701/20; 701/19; 340/10.1

(57) ABSTRACT

A data communication system for a rail vehicle consist includes a data reading device and a processing module. The data reading device is disposed on the consist and is configured to interrogate and read data from a tangible and non-transitory medium that is spaced apart from the data reading device. The processing module is disposed on the rail vehicle consist and is communicatively coupled with the data reading device. The processing module receives the data from the data reading device and uses the data in connection with one or more operations of the rail vehicle consist. A method for communicating data with a rail vehicle consist includes interrogating and reading data from a tangible and non-transitory medium using an electronic reading device while the medium is spaced apart from the reading device and using the data in connection with one or more operations of the rail vehicle consist based on the data.

### CROSS-REFERENCE TO RELATED APPLICATIONS

The present application is a nonprovisional patent application that

claims priority to co-pending U.S. Provisional Application No. 61/415,385, filed 19 Nov. 2010, and entitled “Data Communication System For A Rail Vehicle Consist And Method For Communicating Data With A Rail Vehicle Consist” (the “'385 Application”). The entire disclosure of the '385 Application (including the specification, claims, and drawings) is hereby incorporated by reference in its entirety.

### BACKGROUND

One or more embodiments of the subject matter described herein relate to data communications and, more particularly, to data communications with a rail vehicle.

Rail vehicles may include multiple powered units, such as locomotives, that are mechanically coupled or linked together in a consist. The consist of powered units operates to provide tractive and/or braking efforts to propel and stop movement of the rail vehicle. The powered units in the consist may change the supplied tractive and/or braking efforts based on information that is wirelessly transmitted to the consist, such as by a TCP/IP-based, wireless network.

The information that is wirelessly transmitted to the consist may relate to the cargo that is carried by the consist, a route that the rail vehicle is to traverse during an upcoming trip, emissions limitations on the powered units, speed limits, and the like. The information may be used by a software application, such as Trip Optimizer™ from General Electric Company, to determine the speed of the rail vehicle for various segments of an upcoming trip of the rail vehicle. For example, the software application may use the information to form a trip profile that includes throttle and/or brake settings for various segments of the trip. The powered units may then propel the consist according to the trip profile.

The wireless transmission of the information is subject to several propagation problems. These problems include, but are not limited to, the existence of dead spots or low signal strength areas along the route that the rail vehicle travels, reduced transmission rates due to the need to re-transmit lost data, and the like. Additional problems associated with wireless transmission of data messages include atmospheric interference, mechanical failure of the receiving antenna module, and the like.

A need, exists for a system and method for communicating with a rail vehicle that avoids one or more of the above shortcomings.

### BRIEF DESCRIPTION

In one embodiment, a data communication system for a rail vehicle consist is provided. The system includes a data reading device and a processing module. The data reading device is disposed on a rail vehicle consist and is configured to interrogate and read data from a tangible and non-transitory medium that is spaced apart from the data reading device. The processing module is disposed on the rail vehicle consist and is communicatively coupled with the reading device. The processing module receives the data from the reading device and uses the data in connection with one or more operations of the rail vehicle consist.

In another embodiment, a method for communicating data with a rail vehicle consist is provided. The method includes performing the following operations on a rail vehicle of the rail vehicle consist: interrogating and reading data from a tangible and non-transitory medium using an electronic reading device while the medium is spaced apart from the reading device, and using the data in connection with one or more operations of the rail vehicle consist based on the data.

In another embodiment, a computer readable storage medium of a data communication system in a rail vehicle consist that includes a processor and an electronic reading device is provided. The computer readable storage medium includes one or more sets of instructions that direct the reading device to interrogate and read data from a tangible and non-transitory medium while the medium is spaced apart from the reading device. The instructions also direct the processor to use the data in connection with one or more operations of the rail vehicle consist based on the data.

### BRIEF DESCRIPTION OF THE DRAWINGS

The present invention will be better understood from reading the following description of non-limiting embodiments, with reference to the attached drawings, wherein below:

FIG. 1 is a schematic diagram of one embodiment of a data communication system for a rail vehicle consist;

FIG. 2 is an illustration of one embodiment of the communication system that includes an optical scanner as the data reading device shown in FIG. 1;

FIG. 3 is an illustration of another embodiment of the communication system that includes an RFID interrogator device or reader as the data reading device shown in FIG. 1;

FIG. 4 is a schematic illustration of one embodiment of a data generation system and. the communication system shown in FIG. 1; and

FIG. 5 is a flowchart of one embodiment of a method for communicating data with a rail vehicle consist.

### DETAILED DESCRIPTION

Reference will be made below in detail to embodiments of the inventive subject matter, examples of which are illustrated in the accompanying drawings. Wherever possible, the same reference numerals used throughout the drawings refer to the same or like parts. Although example embodiments of the inventive subject matter are described with respect to trains, locomotives, and other rail vehicles, embodiments also may be applicable for use with vehicles generally, such as off-highway vehicles, agricultural vehicles, and/or transportation vehicles, each of which may include a vehicle consist. A vehicle consist is a group of powered units (such as locomotives) or other vehicles that are mechanically coupled or linked together to travel along a route, with each vehicle in the consist being adjacent to one or more other vehicles in the consist. By way of example, a rail vehicle consist (e.g., train) may include several powered and non-powered units or cars, with the powered units being capable of self-propulsion and the non-powered units being incapable of self-propulsion. A locomotive consist may include several powered units (e.g., locomotives) that coordinate the tractive and/or braking efforts provided by the powered units such that the locomotive consist operates as a single unit. The rail vehicle consist may include one or more locomotive consists.

At least one embodiment described herein provides for communication systems that communicate data with a rail vehicle consist by optically and/or electromagnetically scanning or reading the data. For example, the data may be encoded or recorded in an image, such as a printed bar code or an electronically presented bar code, or in a radio frequency identification (RFID) tag or label. The data can be provided on a tangible and non-transitory medium, such as a paper document, handheld (portable) electronic device having a display device (e.g., mobile phone or personal digital assistant), and the like. In one embodiment, the data is provided as a bar code that is printed on a train manifest document. A data reading device interrogates the medium that includes the data (e.g., transmits light beams or electromagnetic waves toward the medium having the printed image or RFID tag) in order to read the data from the medium.

The data can be optically and/or electromagnetically read from the tangible and non-transitory medium for use by the rail vehicle consist. The data may represent or include a variety of information. By way of example, the data may include trip data, train data, track data, and/or an update to trip data, train data, or track data. Train data includes information about the rail vehicle consist and/or cargo being carried by the rail vehicle consist. For example, train data may represent cargo content (such as information representative of cargo being transported by the rail vehicle consist) and/or rail vehicle information (such as model numbers, manufacturers, horsepower, and the like, of locomotives and/or other railcars in the rail vehicle consist). Trip data includes information about an upcoming trip by the rail vehicle consist. By way of example only, trip data may include a trip profile of an upcoming trip of the rail vehicle (such as information that can be used to control one or more operations of the rail vehicle consist, such as tractive and/or braking efforts provided during the powered units of the rail vehicle consist during an upcoming trip), station information (such as the location of a beginning station where the upcoming trip is to begin and/or the location of an ending station where the upcoming trip is to end), restriction information (such as work zone identifications, or information on locations where the track is being repaired or is near another track being repaired and corresponding speed/throttle limitations on the rail vehicle consist), and/or operating mode information (such as speed/throttle limitations on the rail vehicle consist in various locations, slow orders, and the like). Track data includes information about the track or rails upon which the rail vehicle consist travels. For example, the track data can include information about locations of damaged sections of a track, locations of track sections that are under repair or construction, the curvature and/or grade of a track, GPS coordinates of the track, and the like. The track data is related to operations of the rail vehicle consist as the track data includes information about the track that the rail vehicle consist is or will be traveling on. However, other types of data can be recorded as the data and/or the data may be used for other operations. The term “data” may refer to trip data, train data, and track data, only one of trip data, train data, or track data, or another type of data.

One or more embodiments of the disclosed systems can be retrofitted to an existing rail vehicle consist. For example, data reading devices that optically and/or electromagnetically interrogate a tangible and non-transitory medium to read data from the medium may be added to one or more locomotives or other cars of the rail vehicle consist. The data reading devices can be or communicatively coupled with microcontrollers, processors, or computing devices (referred to as “microcontrollers” herein) disposed on-board the rail vehicle consist. The data reading devices communicate the data acquired by optically scanning the medium or electromagnetically reading the data from an RFID tag to the microcontroller. In one embodiment, the microcontroller uses the data in connection with one or more operations of the rail vehicle consist, such as in formulating a trip profile or otherwise controlling tractive and/or braking effort of the consist. At least one technical effect of one or more embodiments described herein is the reading or scanning of data from a tangible and non-transitory medium, such as a train manifest document, such that the data is used to control one or more operations of the rail vehicle consist. For example, a bar code or RFID tag on a document can be used to communicate data to the rail vehicle consist, which is then used by a propulsion subsystem of the rail vehicle consist to control tractive and/or braking efforts based, on the data.

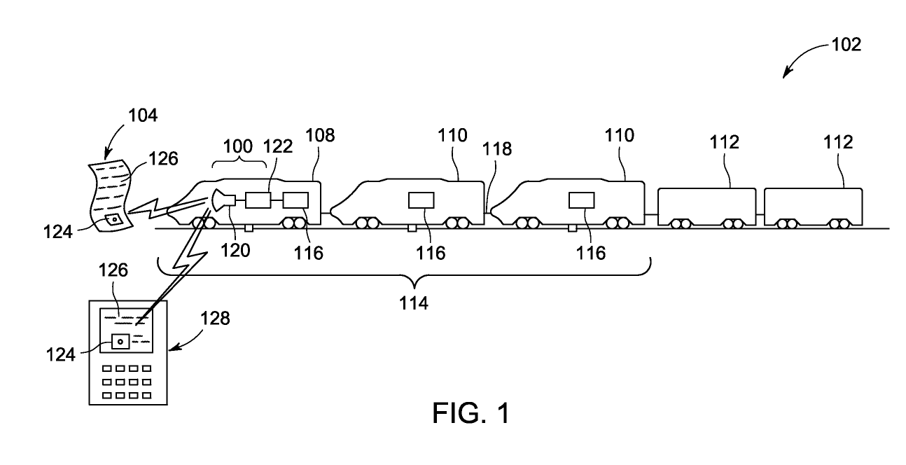

FIG. 1 is a schematic diagram of one embodiment of a data communication system 100 for a rail vehicle consist 102. As described above, in one embodiment, the communication system 100 permits optical and/or electromagnetic reading of data from a tangible and non-transitory medium 104, 128, such as a printed document (e.g., a train manifest document) or a handheld electronic device (e.g., a mobile phone, personal digital assistant, or tablet personal computer). The optical and/or electromagnetic reading of the data can permit easier and more reliable communication of the data to the communication system 100 of the rail vehicle consist 102. For example, the physically recorded data may communicate the data faster and. may avoid outside interference with communication of the data. Whereas wireless transmission of data can be relatively slow and/or unreliable, the reading of the data using an optical scanning device and/or RFID interrogating device can reliably communicate the data relatively fast.

The rail vehicle consist 102 includes several interconnected powered units 108, 110 and non-powered units 112. “Powered units” refers to rail cars that are capable of self-propulsion, such as locomotives, “Non-powered units” refers to rail cars that are incapable of self-propulsion, but which may otherwise receive electric power for other services. For example, cargo cars, passenger cars, and other types of rail cars that do not propel themselves may be “non-powered units,” even though the cars may receive electric power for cooling, heating, communications, lighting, and the like. In the illustrated embodiment, the powered units 108, 110 represent locomotives joined with each other in a locomotive consist 114. The locomotive consist 114 represents a group of two or more locomotives in the rail vehicle consist 102 that are mechanically coupled, or linked together to travel along a route. The locomotive consist 114 may be a subset of the rail vehicle consist 102 such that the locomotive consist 114 is included in the rail vehicle consist 102 along with additional powered and/or non-powered units in the rail vehicle consist 102. While the illustrated rail vehicle consist 102 only includes a single locomotive consist 114, alternatively the rail vehicle consist 102 may include two or more locomotive consists 114 joined together or interconnected by one or more intermediate powered or non-powered units that do not. form part of the locomotive consists 114.

The powered units 108, 110 include a lead powered unit 108, such as a lead locomotive, and one or more trailing powered units 110, such as trail locomotives. As used herein, the terms “lead” and “trailing” are designations of different powered units, and do not necessarily reflect positioning of the powered units 108, 110, 112 in the rail vehicle consist 102 or the locomotive consist 114. For example, a lead powered unit may be disposed between two trailing powered units. Alternatively, the term “lead” may refer to the first powered unit in the rail vehicle consist 102 or the locomotive consist 114 and “trailing” powered units refer to powered units positioned after the lead powered unit. In another embodiment, the term “lead” refers to a powered unit that is designated for primary control of the locomotive consist 114 and “trailing” refers to powered, units that are under at least partial control of the lead powered unit.

The powered units 108, 110 include a connection at each end of the powered unit 108, 110 to couple propulsion subsystems 116 of the powered units 108, 110 such that the powered units 108, 110 in the locomotive consist 114 function together as a single tractive unit. The propulsion subsystems 116 include electric and/or mechanical devices and components used to provide tractive effort that propels the powered units 108, 110 and braking effort that slows the powered units 108, 110. The propulsion subsystems 116 of the powered units 108, 110 in the locomotive consist 114 are connected and communicatively coupled, with each other by a network connection 118. In one embodiment, the network connection 118 includes a net port and jumper cable that extends along the rail vehicle consist 102 and between the powered units 108, 110. The network connection 118 may be a cable that includes twenty seven pins on each end that is referred to as a multiple unit cable, or MU cable. Alternatively, a different wire, cable, or bus, or other communication medium, may be used as the network connection 118. For example, the network connection 118 may represent an Electrically Controlled Pneumatic (ECP) brake line, a fiber optic cable, or wireless connection.

In the illustrated embodiment, the communication system 100 is disposed on board the lead powered unit 108. Alternatively, the communication system 100 may be disposed on another powered unit 110 or a non-powered unit 112. In another embodiment, multiple communication systems 100 are provided on the consist 102 with two or more of the communication systems 100 located on different powered and/or non-powered units 110, 112. The communication system 100 includes a data reading device 120 communicatively coupled to a processing module 122. The data reading device 120 is an electronic component that reads the data from the tangible and non-transitory medium 104, 128. The data reading device 120 interrogates the medium 104, 128 with light waves or electromagnetic waves to the medium 104, 128 to optically scan or electromagnetically read the data from the medium 104. In one embodiment, the data is not wirelessly transmitted or otherwise actively transmitted by the medium 104, 128 on which or in which the data is recorded, printed., or otherwise represented. For example, the medium 104, 128 may not wirelessly transmit the data to the data reading device 120.

The data reading device 120 reads data from the tangible and. non-transitory medium 104, 128 that is spaced apart from the data reading device 120 but is located on-board the rail vehicle consist 102 in one embodiment. For example, the data reading device 120 may read the data from the medium 104, 129 only while the medium 104, 128 is located in the same powered or non-powered unit 110, 112 of the rail vehicle consist 102. By “on-board,” it is meant that the data reading device 120 may be located in an interior compartment (e.g., cab) of the powered or non-powered unit 110, 112 or disposed outside of, but coupled to, the powered or non-powered unit 110, 112. For example, the data reading unit 120 may be affixed to the outside of the powered or non-powered unit 110, 112.

In one embodiment, the tangible and non-transitory medium 104, 128 is portable and/or decoupled from rail infrastructure. For example, the medium 104, 128 may be a handheld, object that is carried by a single human operator without assistance from additional machinery or tools, such as a lifting or support mechanism without which a human operator of average strength and size would be unable to lift and carry the medium 104, 128. The medium 104, 128 can be decoupled from rail infrastructure when the medium 104, 128 is not affixed, coupled, joined, or otherwise mechanically engaged with a rail, track, wayside equipment, another rail vehicle consist, and the like. For example, the medium 104, 128 may be decoupled from rail infrastructure when a human operator of average strength and size can lift, carry, or otherwise move the medium 104, 128 relative to a rail, track, wayside equipment, or rail vehicle consist without assistance from the lifting or support mechanisms described above.

The data reading device 120 communicates the data acquired from the medium 104, 128 to the processing module 122. The processing module 122 may use the data in connection with one or more operations of the rail vehicle consist 102. For example, the processing module 122 may use the data to form or change a trip profile that controls tractive and/or braking efforts of the powered units 110 in the rail vehicle consist 102 during a trip. Alternatively, the data may be used for other purposes, such as to track inventory of cargo, a composition of the different powered and/or non-powered units 110, 112 in the consist 102, and the like.

The data reading device 120 can acquire the data from the medium 104, 128 while the medium 104, 128 is spaced apart from the data reading device 120 without the medium 104, 128 wirelessly transmitting the data. For example, the medium 104, 128 may not be coupled or engaged with the data reading device 120, such as by one or more connectors, cables, busses, and the like. By way of example, the medium 104, 128 may be spaced apart from the data reading device 120 by anywhere from less than one inch (2.54 centimeters) to one to two feet (30.5 centimeters to 60.0 centimeters) away from the data reading device 120. However, other distances may be used and the above examples are not intended to be limited on all embodiments described herein. The medium 104, 128 may be located on-board the consist 102, such as inside the same powered and/or non-powered unit 110, 112 in which the communication system 100 is disposed, when the data reading device 120 interrogates or scans the medium 104, 128 to acquire the data.

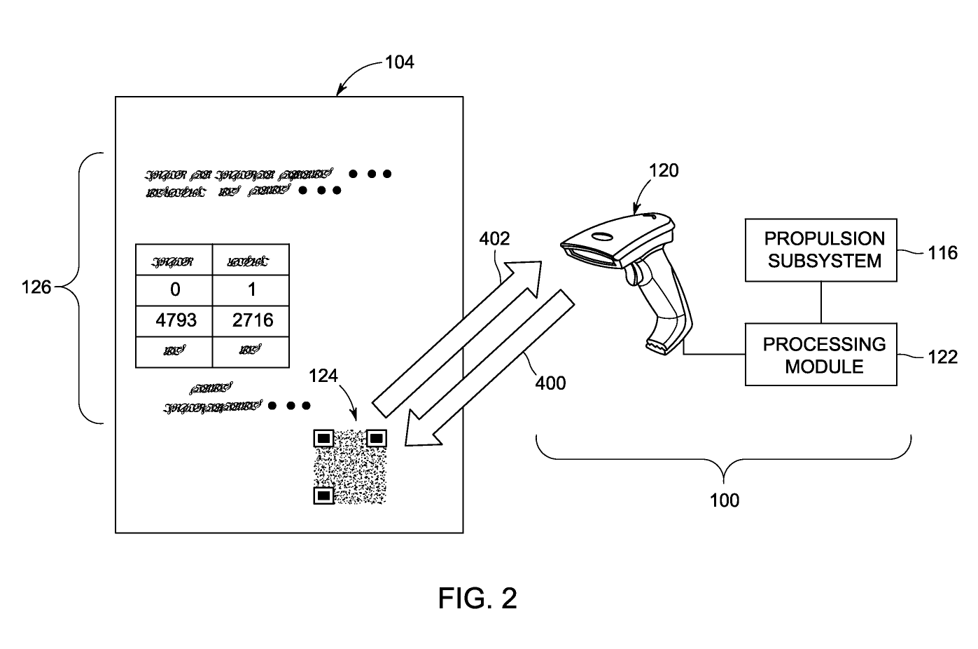

FIG. 2 is an illustration of one embodiment of the communication system 100 that includes an optical scanner as the data reading device 120. The data reading device 120 is illustrated as a handheld optical scanner, but alternatively may be a non-handheld optical scanner, such as an optical scanner that is affixed to one or more structures or components within a powered unit 110 and/or non-powered unit 112 (shown in FIG. 1) of the consist 102 (shown in FIG. 1). The data reading device 120 optically reads an image 124 that is visually presented on the medium 104.

The image 124 may be an optical machine-readable representation of the data, such as a bar code. The bar code can be linear or one-dimensional bar code (such as a U.P.C. bar code), a matrix or two-dimensional bar code (such as an Aztec bar code or QR bar code), a color bar code (such as an image), and the like. The image 124 shown in FIG. 2 is a two-dimensional bar code. The medium 104 can represent a paper document, such as a train manifest. The medium 104 can include human-readable text 126 that is printed on the medium 104. When the train manifest is handed to an operator of the rail vehicle consist 102, the operator may position the medium 104 relatively close to the data reading device 120 in order for the data reading device 120 to interrogate the medium 104 and acquire the data represented by or contained in the image 124. In the illustrated embodiment, the medium 104 is a printed document, such as a paper document with the image 124 printed on the document using ink. Alternatively, the medium 104 may be replaced by the medium 128, such as a display device of an electronic device (e.g., a mobile phone, personal digital assistant, or tablet personal computer). The display device may display the image 124 (such as an electronically displayed bar code) such that the data reading device 120 can optically scan the image 124 to obtain the data. While the discussion herein focuses on the medium 104, the discussion may equally apply to the medium 128.

The data reading device 120 interrogates the medium 104 with light beams 400 (e.g., light waves transmitted by the data reading device 120 toward the medium 104) in order to acquire the data that is represented by or contained in the image 124. At least some of the light beams 400 are reflected off of the image 124 as reflected beams 402, The light beams 400 that strike different portions of the medium 104 and/or image 124 may be reflected differently based on which part of the medium 104 or image 124 that the light beams 400 strike. The reflected beams 402 are reflected off the image 124 back toward the data reading device 120. The data reading device 120 receives the reflected beams 402 and translates the reflected beams 402 into the data represented by the image 124. For example, the data reading device 120 interprets the differently reflected beams 402 in order to identify or discern the data contained in or represented by the image 124. The image 124 provides the data to the data reading device 120 in a non-wirelessly transmitted manner, or in a manner where the data is contained within the medium 104 as opposed, to being wirelessly transmitted in a wireless TCP/IP network or transmitted from the medium 104, 128 to the data reading device 120.

The data reading device 120 is communicatively coupled with the processing module 122, such as by one or more one or more wired or wireless connections. For example, the data reading device 120 may be a handheld and/or portable bar code scanner that is coupled, with the processing module 122 by a wire or cable. Alternatively, the data reading device 120 may be a handheld and/or portable bar code scanner that is wirelessly connected with the processing module 122 over a local area network or other short-range wireless connection (e.g., Bluetooth). The reading range of the data reading device 120 may be limited to a relatively short range, such as one inch (2.54 centimeters) to one to two feet (30.5 centimeters to 60.0 centimeters). For example, the data reading device 120 may be unable to reach the data from the medium 104, 128 when the medium 104, 128 is located relatively far away, such as farther than two feet (60.0 centimeters) from the data reading device 120.

As described below, the processing module 122 receives the acquired data from the data reading device 120 and uses the data in connection with one or more operations of the consist 102 (shown in FIG. 1). By way of example, the processing module 122 may be communicatively coupled with one or more propulsion subsystems 116 of the consist 102 and may use the acquired data to determine a trip profile for the consist 102 and control tractive and/or braking efforts of the propulsion subsystem 116 based on the trip profile. However, other uses of the data may be realized.

Alternatively, the data reading device 120 may be an optical character recognition (OCR) device. Such a data reading device 120 can optically scan the human readable text 126 on the medium 104 (or the medium 128) to obtain the data. For example, the data may be printed on a train manifest document or electronically displayed on an electronic device as text 126 that is readable by a human operator. The data reading device 120 scans the text 126 by transmitting light beams 400 and receiving reflected beams 402 to identify the text 126. The data reading device 120 converts the identified text 126 into the data.

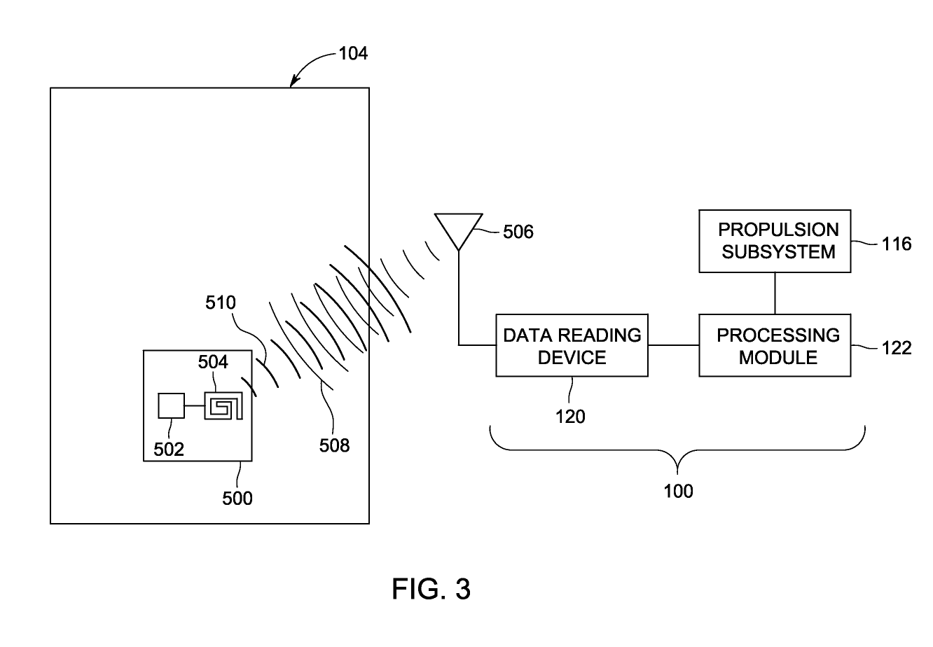

FIG. 3 is an illustration of another embodiment of the communication system 100 that includes an RFID interrogator device or reader (e.g., “RF interrogator”) as the data reading device 120. In the illustrated embodiment, the data reading device 120 is an electromagnetic reading device that transmits and/or receives electromagnetic waves to read the data from the medium 104. The data may be encoded or contained in an RFID tag or label 500 that includes a controller 502 (such as a microchip) and an antenna 504. For example, the image 124 shown in FIG. 1 may represent an RFID tag or label 500 that is affixed to a document, such as a manifest.

The data reading device 120 includes an antenna 506 that generates an interrogation field, toward the RFID tag 500. The interrogation field includes electromagnetic waves 508 transmitted by the antenna 506. The transmitted electromagnetic waves 508 may be the same frequency or the data reading device 120 may sweep through a range of frequencies when transmitting the electromagnetic waves 508. For example, the frequency of the transmitted electromagnetic waves 508 may vary over time. The RFID tag 500 may be an active or passive tag. With respect to active RFID tags 500, the RFID tag 500 may include or be coupled with a power source, such as a battery. The battery may be included in the same package as the controller 502 and/or antenna 504. When the active RFID tag 500 receives the electromagnetic waves 508 transmitted by the antenna 506 of the data reading device 120, the controller 502 causes the antenna 504 to wirelessly transmit responsive electromagnetic waves 504. The antenna 504 is powered by the power source. Alternatively, in the case of a passive RFID tag 500, the antenna 504 receives energy from the transmitted electromagnetic waves 508. The received, energy inductively powers the controller 502 such that the controller 502 directs the antenna 504 to transmit the electromagnetic waves 510 to the antenna 506 of the data reading device 120.

The electromagnetic waves 510 transmitted by the RFID tag 500 include or represent the data associated with the RFID tag 500. The antenna 506 of the data reading device 120 receives the responsive electromagnetic waves 510 and determines the data from the received responsive electromagnetic waves 510.

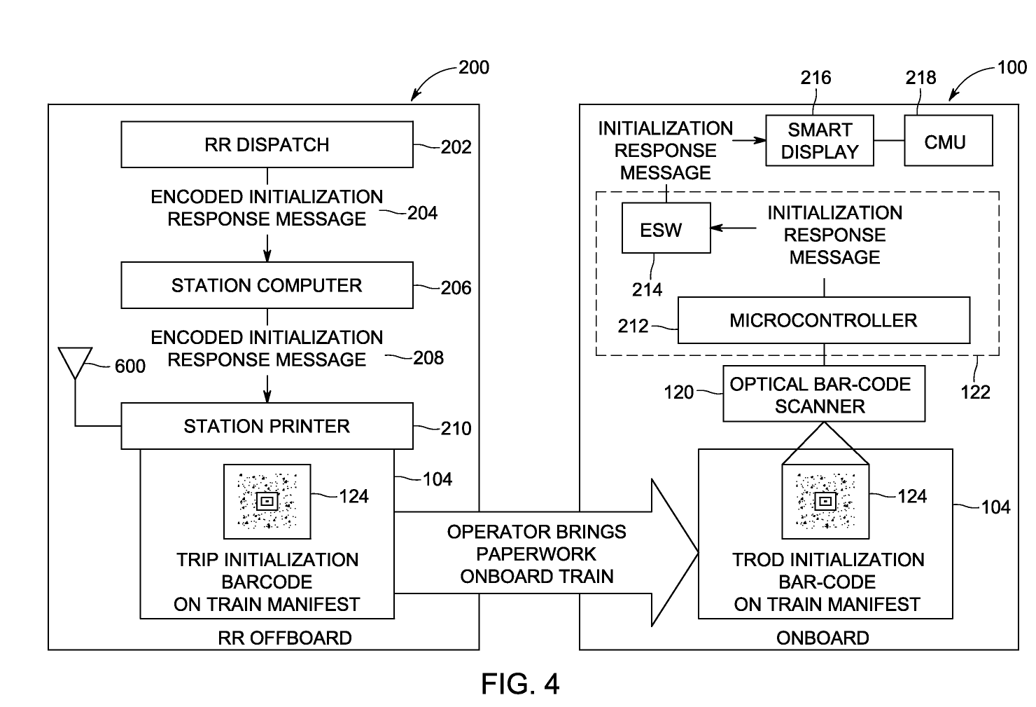

FIG. 4 is a schematic illustration of one embodiment of a data generation system 200 and the communication system 100. FIG. 4 illustrates the flow of the data from a point of origin, such as a railroad dispatch 202 (“RR Dispatch”), to a point of destination, such as the processing module 122 on the rail vehicle consist 102 (shown in FIG. 1). FIG. 4 is described in terms of communicating a trip profile as the data to the rail vehicle consist 102 for a software application of the rail vehicle consist 102 that uses the trip profile to control tractive and/or braking efforts of the rail vehicle consist 102 during an upcoming trip of the rail vehicle consist 102.

The railroad dispatch 202 can represent a computer processor or other computer device that generates the data. For example, the railroad dispatch 202 may include a computer having one or more input devices for receiving the data from a human operator and/or from one or more sensors or other computers. The railroad dispatch 202 may be located in an office or town remote from the rail vehicle consist 102 or in the same railyard. in which the rail vehicle consist 102 is located. The railroad dispatch 202 may create the data in connection with a request for a trip profile. For example, an operator may input a request, such as a trip initialization request, for a trip profile. The trip profile may be used by an energy management or other software application on the rail vehicle consist 102, such as the Trip Optimizer™ software application provided by General Electric Company, to control propulsion operations of the rail vehicle consist 102 during an upcoming trip. (For example, the trip profile may be used by the energy management system as part of the basis for generating a trip or mission plan for the rail vehicle consist, where the rail vehicle consist is controlled based on the trip or mission plan as the rail vehicle consist travels along a route.) The trip profile may be based, at least in part, on the cargo that is carried, by the rail vehicle consist 102. For example, the rail vehicle consist 102 may change propulsion operations differently when different cargoes are carried by the rail vehicle consist 102 over the same trip.

In response to the request, the railroad dispatch 202 communicates a response message 204 (“Encoded Initialization Response Message”) to a station processing module 206 (“Station Computer”). The response message 204 includes the data. Alternatively, the response message 204 may include a field pointer that directs the station processing module 206 to a location where the data is stored. The station processing module 206 may be a computer processor or computer that encodes the data into a form that is readable by the data reading device 120. For example, if the data reading device 120 is an optical scanning device that optically scans the image 124 to obtain the data, then the station processing module 206 may determine the appearance and contents of the image 124 based on the data. Alternatively, if the data reading device 120 is an OCR scanning device, then the station processing module 206 may determine the human-readable text 126 (shown in FIG. 1) that includes the data. In another embodiment, if the data reading device 120 is an electromagnetic scanning device, such as an RFID interrogator, then the station processing module 206 may determine the coding of the data in the controller 502 (shown in FIG. 2) of the RFID tag 500 (shown in FIG. 2). For example, the station processing module 206 may determine the bits that are to be stored on the RFID tag 500 in order to record the data in the RFID tag 500.

The station processing module 206 communicates an encoded response message 208 (“Encoded Initialization Response Message”) to a printing device 210 (“Station Printer”). The encoded response message 208 includes the data in an encoded form. By “encoded form,” it is meant that the data that is output from the station processing module 206 has been converted or changed from one format or language to another format or language. For example, the response message 204 that is input into the station processing module 206 may be incapable of being used by a printer or handheld, electronic device to visually present the image 124, such as by printing the image 124 onto paper or displaying the image on a handheld electronic device. Conversely, the encoded response message 208 is in a different, encoded form such that the encoded response message 208 can be used by a printer or handheld electronic device to create the image 124.

The printing device 210 is an electronic device that converts the encoded response message 208 into the image 124. For example, the printing device 210 may be a laser jet printer (or other device capable of printing the image 124 on a paper document) that prints the image 124 with ink onto the medium 104, such as a paper document. In the illustrated embodiment, the medium 104 is one or more pages of a train manifest document (“Trip Initialization Barcode On Train Manifest”). Additional human-readable text 126 (shown in FIG. 1) also may be printed onto the medium 104 by the printing device 210. Alternatively, the printing device 210 may be a transceiver that communicates the image 124 to a handheld electronic device. For example, the printing device 210 may communicate the image 124 over a wired or wireless connection to a mobile phone, personal digital assistant, and the like, so that the image 124 can be displayed on the phone or personal digital assistant.

In another embodiment, the printing device 210 is a programming device that programs the data into the RFID tag 500 (shown in FIG. 2). For example, the printing device 210 may include an antenna 600 that transmits the data to the RFID tag 500 for storage therein. The RFID tag 500 may be the medium 104 or the RFID tag 500 be attached or affixed to the medium 104.

Once the image 124 (e.g., bar code or RFID tag/label) is created by the printing device 210, the medium 104 or 128 is carried to the communication system 100. For example, the medium 104 or 128 may be a handheld object capable of being carried by a single human operator. The medium 104 or 128 is carried to the data reading device 120 of the communication system 100. In the illustrated embodiment, the data reading device 120 is referred to as an “Optical Bar-Code Scanner.” Alternatively, as described herein, the data reading device 120 may be an RFID interrogation or reading device. The data reading device 120 scans or reads the image 124 from the medium 104 to obtain the data. In another embodiment, the data reading device 120 scans or reads the image 124 from the medium 128 (shown in FIG. 1) to obtain the data. Alternatively, the data reading device 120 may scan or read the human-readable text printed on the medium 104 or 128 to obtain the data.

The data is communicated from the data reading device 120 to the processing module 122. In the illustrated embodiment, the processing module 122 includes a microcontroller 212, such as a computer microprocessor or processor. The microcontroller 212 examines the data received from the data reading device 120 to determine the destination of the data. Different parts of the data may be directed or addressed to different components of the rail vehicle consist 102. The microcontroller 212 may determine where to send all or part of the data based on the contents of the data. For example, if the data includes cargo content information and/or a trip profile for the rail vehicle consist 102, then the microcontroller 212 may communicate the data (or a portion thereof) to a software module 214 that uses the data.

The software module 214 (“ESW”) represents a set of instructions for a computer processor, such as the microcontroller 212, that are stored on a tangible and non-transitory computer readable medium, such as a computer hard drive, ROM, RAM, EEPROM, flash drive, CD, DVD, and the like. The software module 214 may be embodied in one or more software applications that are stored on a computer memory. The software module 214 examines the data received from the microcontroller 212 and determines how the data is to be used to control one or more operations of the rail vehicle consist 102 (shown in FIG. 1). For example, the software module 214 may determine that the data is to be used to control tractive and/or braking efforts provided by one or more propulsion subsystems 116 (shown in FIG. 1) of the rail vehicle consist 102 during an upcoming trip of the rail vehicle consist 102. Alternatively, the software module 214 may determine that the data is to be used for other operations, such as monitoring the contents of cargo received or offloaded by the rail vehicle consist 102. The above examples are not limitations on how the data may be used but are provided merely as example embodiments.

In the illustrated embodiment, the processing module 122 is coupled with a display device 216 (“Smart Display”). The processing module 122 may direct the display device 216 to visually present the data to an operator of the rail vehicle consist 102 (shown in FIG. 1). For example, the display device 216 may be a monitor, touchscreen, or other electronic device capable of visually presenting information. The display device 216 may present the data to the operator so that the operator is aware of the data and/or so that the operator can verify the accuracy and/or completeness of the data.

The processing module 122 also may be coupled with a controller processing module 218 (“CMU”). The controller processing module 218 may be a computer processor or microprocessor that operates based on one or more sets of instructions stored on a tangible and non-transitory computer readable storage medium, such as or similar to the software module 214. The controller processing module 218 may use the data to control operations of the rail vehicle consist 102 (shown in FIG. 1). For example, the controller processing module 218 may be communicatively coupled with the propulsion subsystems 116 (shown in FIG. 1) of the powered units 108, 110 (shown in FIG. 1). The controller processing module 218 can examine the data and change the tractive and/or braking efforts of one or more of the powered units 108, 110 based on the data and/or a trip profile for the rail vehicle consist 102. For example, if the rail vehicle consist 102 is approaching a steep incline and the data indicates that the rail vehicle consist 102 is carrying significantly heavy cargo, then the controller processing module 218 may direct one or more of the powered units 108, 110 to increase the tractive efforts supplied by the powered units 108, 110. Conversely, if the rail vehicle consist 102 is carrying a smaller cargo load based on the data, then the controller processing module 218 may direct the powered units 108, 110 to increase the supplied tractive efforts by a smaller amount than the tractive efforts would otherwise be increased if the data indicated a heavier cargo load. The tractive and/or braking efforts may be changed in response to other factors, such as changes in the track that the rail vehicle consist 102 travels along, regulatory requirements (e.g., emission limits) of the regions through which the rail vehicle consist 102 travels, and the like, and based on the data.

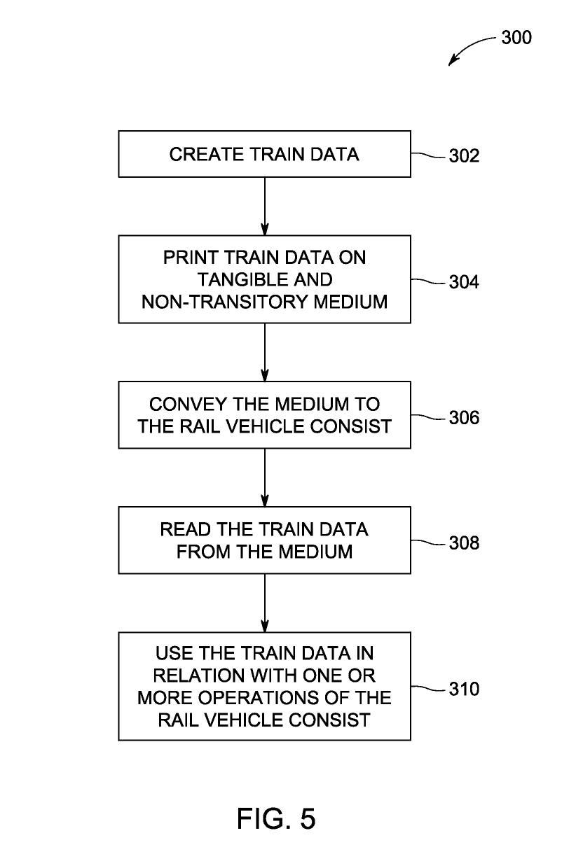

FIG. 5 is a flowchart of one embodiment of a method 300 for communicating data with a rail vehicle consist. The method 300 may be used in conjunction with one or more embodiments of the communication system 100 (shown in FIG. 1) described herein.

At 302, data is created. For example, an operator may input data, such as details about the cargo being transported by a rail vehicle consist, into a computer device. Alternatively, the data may be automatically received from sensors or other input devices.

At 304, the data is printed onto a tangible and non-transitory medium. For example, the data may be printed as an image, such as a bar code, or human-readable text onto a paper document, such as a train manifest document. Alternatively, the data may be printed on another object. In another embodiment, the data may be displayed on a display device of an electronic component, such as a handheld electronic device. Alternatively, the data may be programmed onto an RFID tag or label. For example, instead of printing the data, the data may be stored on an RFID tag or label.

At 306, the medium that contains the data is conveyed to the rail vehicle consist. For example, the paper document (e.g., a train manifest), handheld electronic device, or RFID tag may be carried by a single human operator to the rail vehicle consist.

At 308, the data is read from the medium. For example, the data may be optically scanned from the paper document or electromagnetically read from the RFID tag or label. In one embodiment, the data is optically scanned from an image, such as a bar code, or from human-readable text, such as through OCR techniques. Alternatively, the data is electromagnetically read by an RFID interrogating device.

At 310, the data is used in relation with one or more operations of the rail vehicle consist. For example, after reading the data, the data may be used to formulate a trip profile for an upcoming trip of the rail vehicle consist, where the trip profile is used to change or control propulsion of the rail vehicle consist during the trip. Alternatively, the data may be used to inventory or track the contents of cargo stored on the rail vehicle consist. The data may be used for other operations associated with the rail vehicle consist than those listed above.

One or more embodiments described herein provide for systems and methods for communicating data with a rail vehicle consist. The data may be transmitted in a more reliable manner than heretofore used, such as by containing the data in a bar code or other image, human-readable text, an RFID tag or label, and the like, and scanning or reading the data from the bar code, image, text, RFID tag or label. Communicating the data in this manner may be more reliable and/or faster than some known methods of communicating the data.

In one embodiment, a data communication system for a rail vehicle consist is provided. The system includes a data reading device and a processing module. The data reading device is disposed on a rail vehicle consist and is configured, to interrogate and read data from a tangible and non-transitory medium that is spaced apart from the data reading device. The processing module is disposed on the rail vehicle consist and is communicatively coupled with the data reading device. The processing module receives the data from the data reading device and uses the data in connection with one or more operations of the rail vehicle consist.

In another aspect, the data reading device is an optical scanning device configured to optically scan the data from the tangible and non-transitory medium.

In another aspect, the data is presented as optical machine-readable data.

In another aspect, the data is presented as at least one of a bar code, an image, or text.

In another aspect, the tangible and non-transitory medium is at least one of a document or a display device, and the data is at least one of printed on the document or electronically displayed on the display device.

In another aspect, the tangible and non-transitory medium is a radio frequency identification (RFID) tag with the data encoded in the RFID tag, and the data reading device is an RFID interrogator device configured to read the data from the RFID tag using electromagnetic waves of an interrogation field, emitted by the RFID interrogator device.

In another aspect, the processing module is coupled to a propulsion subsystem of a powered unit in the rail vehicle consist and is configured to use the data to control at least one of tractive effort or braking effort provided by the propulsion subsystem based on the data.

In another embodiment, a method for communicating data with a rail vehicle consist is provided. The method includes performing the following operations on a rail vehicle of the rail vehicle consist: interrogating and reading data from a tangible and non-transitory medium using an electronic reading device while the medium is spaced apart from the reading device, and using the data in connection with one or more operations of the rail vehicle consist based on the data.

In another aspect, the interrogating and reading step includes optically scanning the data from the tangible and non-transitory medium.

In another aspect, the method also includes printing the data on the tangible and non-transitory medium.

In another aspect, the interrogating and reading step includes reading the data from at least one of a bar code, an image, or text that is printed, on the tangible and non-transitory medium.

In another aspect, the tangible and non-transitory medium is at least one of a document or a display device and the data is printed on the document or electronically displayed on the display device, and the interrogating and reading step includes reading the data from the document or the display device,

In another aspect, the tangible and non-transitory medium is a radio frequency identification (RFID) tag with the data encoded in the RFID tag, and the interrogating and reading step includes interrogating the RFID tag with an interrogation field of electromagnetic waves emitted by an RFID interrogator device,

In another aspect, the using step includes processing the data on a powered unit in the rail vehicle consist to control at least one of tractive effort or braking effort provided by the powered unit based on the data.

In an embodiment, the method for communicating data with a rail vehicle consist includes a step of interrogating and reading data from a tangible and non-transitory medium using an electronic reading device while the medium is spaced apart from the reading device, and a step of using the data in connection with one or more operations of the rail vehicle consist. In another embodiment, the method for communicating data with a rail vehicle consist includes a step of interrogating and reading data from a tangible and non-transitory medium using an electronic reading device while the medium is spaced apart from the reading device, and a step of controlling one or more operations of the rail vehicle consist based on the data. In another embodiment, the method for communicating data with a rail vehicle consist includes a step of interrogating and reading data from a tangible and non-transitory medium using an electronic reading device while the medium is spaced apart from the reading device, and a step of controlling the rail vehicle consist based on the data.

In another embodiment, a computer readable storage medium of a data communication system in a rail vehicle consist that includes a processor and an electronic reading device is provided. The computer readable storage medium includes one or more sets of instructions that direct the reading device to interrogate and read data from a tangible and non-transitory medium while the medium is spaced apart from the reading device. The instructions also direct the processor to use the data in connection with one or more operations of the rail vehicle consist based on the data.

In another aspect, the sets of instructions direct the reading device to optically scan the data from the tangible and non-transitory medium.

In another aspect, the tangible and non-transitory medium is at least one of a document or a display device and the data is printed on the document or electronically displayed on the display device, and the sets of instructions direct the reading device to optically scan the data from the document or the display device.

In another aspect, the data is represented as at least one of a bar code, an image, or text printed on the tangible and non-transitory medium.

In another aspect, the tangible and non-transitory medium is a radio frequency identification (RFID) tag with the data encoded in the RFID tag, and the sets of instructions direct the reading device to interrogate the RFID tag with an interrogation field of electromagnetic waves to read the data.

In another aspect, the sets of instructions direct the processor to process the data to control at least one of a tractive effort or a braking effort provided by a powered unit in the rail vehicle consist.

Another embodiment relates to a data communication system for a rail vehicle consist. The system includes an optical scanning device and a processing module. The optical scanning device is disposed on the rail vehicle consist, and is configured to interrogate and read data from a tangible and non-transitory medium that is spaced apart from the optical scanning device and located on-board the rail vehicle consist. The medium is a printed document or an electronically presented display on a portable display device. The data is presented as at least one of a bar code, an image, or text on the printed document or the electronically presented display on the portable display device. The processing module is disposed on the rail vehicle consist and communicatively coupled with the optical scanning device. The processing module is configured, to receive the data from the data reading device and to use the data, or to communicate the data to another part of the rail vehicle consist that uses the data, for generating an initial trip plan of the rail vehicle consist. (The rail vehicle consist is controlled along at least an initial part of a route of the rail vehicle consist according to the initial trip plan.)

Another embodiment relates to a data communication system for a rail vehicle consist. The system includes an optical scanning device and a processing module. The optical scanning device is configured to be disposed on the rail vehicle consist, and is configured to interrogate and read data from a tangible and non-transitory medium (e.g., printed document or an electronically presented display on a portable display device) that is spaced apart from the optical scanning device and located on-board the rail vehicle consist (e.g., the data is presented as at least one of a bar code, an image, or text on the printed document or the electronically presented display on the portable display device). The processing module is configured to be communicatively coupled with the optical scanning device, and with a control system of the rail vehicle consist. (The processing module may be a hardware and/or software module, that is, it may include electronic components and/or a set of machine readable instructions that when executed by a designated electronic device cause the electronic device to perform one or more functions as specified in the instructions.) The processing module is configured to interface the optical scanning device with the control system for providing the data read by the optical scanning device to the control system, for the control system to use the data in controlling the rail vehicle consist. For example, the data may include information used by the control system for generating an initial trip plan of the rail vehicle consist. (The rail vehicle consist would be controlled along at least an initial part of a route of the rail vehicle consist according to the initial trip plan.)

Another embodiment relates to a data communication system for a rail vehicle consist. The system includes an optical scanning device and a processing module. The optical scanning device is disposed on the rail vehicle consist, and interrogates and reads data from a tangible and non-transitory medium (e.g., printed document or an electronically presented display on a portable display device) that is spaced apart from the optical scanning device and located on-board the rail vehicle consist (e.g., the data is presented as at least one of a bar code, an image, or text on the printed document or the electronically presented display on the portable display device). The processing module is communicatively coupled with the optical scanning device, and with a control system of the rail vehicle consist. (The processing module may be a hardware and/or software module, that is, it may include electronic components and/or a set of machine readable instructions that when executed by a designated electronic device cause the electronic device to perform one or more functions as specified in the instructions.) The processing module interfaces the optical scanning device with the control system for providing the data read by the optical scanning device to the control system, for the control system to use the data in controlling the rail vehicle consist. For example, the data may include information used by the control system for generating an initial trip plan of the rail vehicle consist. (The rail vehicle consist is controlled along at least an initial part of a route of the rail vehicle consist according to the initial trip plan.)

In another embodiment, a data communication system for a rail vehicle consist is provided. The system includes a radio frequency (RF) interrogator and a processing module. The RF interrogator is disposed on the rail vehicle consist and is configured to interrogate a radio frequency identification (RFID) tag with electromagnetic waves to read data encoded in the RFID tag. The RF interrogator reads the data from the RFID tag when the RFID tag is spaced apart from the RF interrogator and located, on-board the rail vehicle consist. The processing module is disposed on the rail vehicle consist and is communicatively coupled with the RF interrogator. The processing module is configured to receive the data from the RF interrogator and to use the data, or to communicate the data to another part of the rail vehicle consist that uses the data, for generating an initial trip plan of the rail vehicle consist, wherein the rail vehicle consist is controlled along at least an initial part of a route of the rail vehicle consist according to the initial trip plan. (The rail vehicle consist is controlled along at least an initial part of a route of the rail vehicle consist according to the initial trip plan.)

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to one of ordinary skill in the art upon reviewing the above description. The scope of the subject matter described herein should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments of the invention, including the best mode, and also to enable any person of ordinary skill in the art to practice the embodiments disclosed herein, including making and using any devices or systems and performing any incorporated methods. The patentable scope of the subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

The foregoing description of certain embodiments of the disclosed subject matter will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general purpose signal processor, microcontroller, random access memory, hard disk, and the like). Similarly, the programs may be stand alone programs, may be incorporated as subroutines in an operating system, may be functions in an installed software package, and the like. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

Since certain changes may be made in the above-described systems and methods for communicating with a rail vehicle, without departing from the spirit and scope of the subject matter herein involved, it is intended that all of the subject matter of the above description or shown in the accompanying drawings shall be interpreted merely as examples illustrating the inventive concepts herein and shall not be construed as limiting the disclosed subject matter.

What is claimed is:

1. A data communication system for a rail vehicle consist, the system comprising:
a data reading device disposed on the rail vehicle consist, the reading device configured to interrogate and read data from a tangible and non-transitory medium that is spaced apart from the data reading device; and
a processing module disposed on the rail vehicle consist and communicatively coupled with the data reading device, the processing module receiving the data from the data reading device and using the data in connection with one or more operations of the rail vehicle consist.

2. The system of claim 1, wherein the data reading device is an optical scanning device configured, to optically scan the data from the tangible and non-transitory medium.

3. The system of claim 1, wherein the data is presented as optical machine-readable data.

4. The system of claim 1, wherein the data is presented as at least one of a bar code, an image, or text.

5. The system of claim 1, wherein the tangible and non-transitory medium is at least one of a document or a display device, and the data is at least one of printed on the document or electronically displayed on the display device.

6. The system of claim 1, wherein the tangible and non-transitory medium is a radio frequency identification (RFID) tag with the data encoded in the RFID tag, and the reading device is an RFID interrogator device configured to read the data from the RFID tag using electromagnetic waves of an interrogation field emitted by the RFID interrogator device.

7. The system of claim 1, wherein the processing module is coupled to a propulsion subsystem of a powered unit in the rail vehicle consist and is configured to use the data to control at least one of tractive effort or braking effort provided by the propulsion subsystem based on the data.

8. A method for communicating data with a rail vehicle consist, the method comprising, on a rail vehicle of the rail vehicle consist:
interrogating and reading data from a tangible and non-transitory medium using an electronic reading device while the medium is spaced apart from the reading device; and
using the data in connection with one or more operations of the rail vehicle consist based, on the data.

9. The method of claim 8, wherein the interrogating and reading step includes optically scanning the data from the tangible and non-transitory medium.

10. The method of claim 8, further comprising printing the data on the tangible and non-transitory medium,

11. The method of claim 8, wherein the interrogating and reading step includes reading the data from at least one of a bar code, an image, or text that is printed on the tangible and non-transitory medium.

12. The method of claim 8, wherein the tangible and non-transitory medium is at least one of a document or a display device and the data is at least one of printed on the document or electronically displayed on the display device, and the interrogating and reading step includes reading the data from the document or the display device.

13. The method of claim 8, wherein the tangible and non-transitory medium is a radio frequency identification (RFID) tag with the data encoded in the RFID tag, and the interrogating and reading step includes interrogating the RFID tag with an interrogation field of electromagnetic waves emitted by an RFID interrogator device.

14. The method of claim 8, wherein the using step includes processing the data on a powered unit in the rail vehicle consist to control at least one of tractive effort or braking effort provided by the powered unit based on the data.

15. A computer readable storage medium of a data communication system in a rail vehicle consist that includes a processor and an electronic reading device, the computer readable storage medium including one or more sets of instructions that:
direct the reading device to interrogate and read data from a tangible and non-transitory medium while the medium is spaced apart from the reading device; and
direct the processor to use the data in connection with one or more operations of the rail vehicle consist based on the data.

16. The computer readable storage medium of claim 15, wherein the sets of instructions direct the reading device to optically scan the data from the tangible and non-transitory medium.

17. The computer readable storage medium of claim 16, wherein the tangible and non-transitory medium includes at least one of a document or a display device and the data is printed on the document or electronically displayed on the display device, and the sets of instructions direct the reading device to optically scan the data from the document or the display device.

18. The computer readable storage medium of claim 16, wherein the data is represented as at least one of a bar code, an image, or text printed on the tangible and non-transitory medium.

19. The computer readable storage medium of claim 15, wherein the tangible and non-transitory medium is a radio frequency identification (RFID) tag with the data encoded in the RFID tag, and the sets of instructions direct the reading device to interrogate the RFID tag with an interrogation field of electromagnetic waves to read the data.

20. The computer readable storage medium of claim 15, wherein the sets of instructions direct the processor to process the data to control at least one of a tractive effort or a braking effort provided by a powered unit in the rail vehicle consist.

21. A data communication system for a rail vehicle consist, the system comprising:
an optical scanning device disposed on the rail vehicle consist, the optical scanning device configured, to interrogate and read data from a tangible and non-transitory medium that is spaced apart from the optical scanning device and located on-board the rail vehicle consist, wherein the medium is a printed document or an electronically presented display on a portable display device, and wherein the data is presented as at least one of a bar code, an image, or text on the printed document or the electronically presented display on the portable display device; and
a processing module disposed on the rail vehicle consist and communicatively coupled with the optical scanning device, the processing module configured to receive the data from the data reading device and to use the data, or to communicate the data to another part of the rail vehicle consist that uses the data, for generating an initial trip plan of the rail vehicle consist, wherein the rail vehicle consist is controlled along at least an initial part of a route of the rail vehicle consist according to the initial trip plan.

22. A data communication system for a rail vehicle consist, the system comprising:
a radio frequency (RF) interrogator disposed on the rail vehicle consist, the RF interrogator configured to interrogate a radio frequency identification (RFID) tag with electromagnetic waves to read data encoded in the RFID tag, wherein the RF interrogator reads the data from the RFID tag when the RFID tag is spaced apart from the RF interrogator and located on-board the rail vehicle consist; and
a processing module disposed on the rail vehicle consist and communicatively coupled with the RF interrogator, the processing module configured to receive the data from the RF interrogator and to use the data, or to communicate the data to another part of the rail vehicle consist that uses the data, for generating an initial trip plan of the rail vehicle consist, wherein the rail vehicle consist is controlled along at least an initial part of a route of the rail vehicle consist according to the initial trip plan.
